(19) United States
(12) Patent Application Publication
(10) Pub. No.: US 2007/0259979 A1
(43) Pub. Date: Nov. 8, 2007

(54) ORGANIC AEROGELS REINFORCED WITH INORGANIC AEROGEL FILLERS

(75) Inventor: Je Kyun Lee, Brookline, MA (US)

Correspondence Address: ASPEN AEROGELS INC.;IP DEPARTMENT, 30 FORBES ROAD, BLDG. B, NORTHBOROUGH, MA, 01532, US

(73) Assignee: ASPEN AEROGELS, INC., Northborough, MA (US)

(21) Appl. No.: 11/743,944

(22) Filed: May 3, 2007

Related U.S. Application Data
(60) Provisional application No. 60/746,328, filed on May 3, 2006.

(51) Int. Cl. C08J 9/28

(52) U.S. Cl. 521/64

(57) ABSTRACT

Composites comprising organic aerogel matrix and inorganic aerogel fillers are described. The methods of manufacturing such composite aerogels are also described. Inorganic aerogels fillers are demonstrated to improve the thermal performance of organic aerogels. Composite aerogels with various organic aerogels and inorganic aerogel fillers are described.

### CROSS-REFERENCES TO RELATED APPLICATIONS

This application claims benefit of priority from U.S. Provisional Patent Application 60/746,328 filed May 3, 2006. The previous application is hereby incorporated by reference in its entirity as if fully set forth.

### FIELD OF INVENTION

The present invention relates to organic aerogels comprising inorganic aerogel fillers. More specifically, the present invention involves inorganic aerogel fillers incorporated into the organic aerogels to produce aerogel composites.

### SUMMARY OF THE INVENTION

Embodiments of the present invention describe a composite comprising an organic aerogel matrix and inorganic aerogel fillers. The organic aerogel matrix preferably comprises isocyanates, polyisocyantes, polyurea, polyurethane, polybutadiene, polycyanurates, polyacrylates, polystyrenes, cellulose, polydicyclopentadiene, polyacrylonitriles, polyimides, polyfurfuryl alcohol, phenol furfuryl alcohol, melamine formaldehydes, resorcinol formaldehydes, cresol formaldehyde, phenol formaldehyde, phloroglucinol formaldehyde, polyvinyl alcohol dialdehyde, polyacrylamides, epoxies, agar, agarose, or a combination thereof. The inorganic aerogel fillers may comprise: silica, titania, zirconia, alumina, hafnia, yttria, ceria, nitrides, carbides or a combination thereof. Weight ratio of organic aerogel to inorganic aerogel fillers in the composite may be between about 1:0.01 and about 1:2. The fillers may have diameters between about 0.01 μm and about 100 μm or between about 0.5 μm and about 50 μm; and/or pore sizes between 0.1 nm and about 200 nm; and/or pore volumes greater than about 2.0 cm³/g; and/or surface areas greater than about 500 m²/g. These resulting composites typically exhibit densities between about 0.01 g/cm³ and about 0.4 g/cm³.

The composite of the present invention may further comprise a fibrous structure such as a woven, non-woven, mat, felt, batting, chopped fibers or a combination thereof. The composite may be in the form of a rigid panel or in the form of flexible aerogel blanket. Furthermore, opacifiers can be incorporated in the composite to reduce the radiative component of heat transfer. Examples of opacifiers include: B₄C, Diatomite, manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or a mixture thereof. A method for preparing such composites includes the steps of: (a) forming a gel from a mixture comprising organic gel precursors, inorganic aerogel fillers; and (b) drying said gel. Drying is preferably carried out using supercritical fluids such as supercritical CO₂.

Embodiments of the present invention describe organic aerogels comprising inorganic aerogel fillers. Within the context of embodiments of the present invention “aerogels” or “aerogel materials” along with their respective singular forms, refer to gels containing air as a dispersion medium in a broad sense, and gels dried with supercritical fluids in a narrow sense. “Fillers” as used herein means an inert material added to modify property or improve quality.

Aerogel composites of the present invention comprise a polymeric organic aerogel matrix with inorganic aerogel particulates embedded therein. Numerous advantages including improved strength and thermal conductivity result from this aerogel composite. First, addition of reinforcing inorganic aerogel particles contributes to a stronger material potentially exhibiting stronger compressive strength. Second and most surprisingly, dramatic improvement in thermal conductivity is achieved with increasing inorganic aerogel filler content (see FIGS. 1 and 2) The second improvement is highly noteworthy since, and without being limited by theory, it is generally unexpected that an increase in the solid matter per unit volume of a material (along with accompanying microstructural changes) would necessarily result in reduced thermal conductivity; particularly, such dramatic improvements as shown in the accompanying figures and table. Finally, the addition of reinforcing inorganic aerogel particles significantly mitigate shrinkage of organic aerogels that inevitably occur during sol-gel processing and supercritical drying.

The preferred synthesis route in embodiments of the present invention involves the sol-gel process where a solution comprising organic gel precursors and inorganic aerogel fillers forms a gel. Subsequent drying of said gel results in a composite comprising an organic aerogel matrix with inorganic aerogels embedded therein. The sol-gel process is described in detail in Brinker C. J., and Scherer G. W., Sol-Gel Science; New York: Academic Press, 1990; hereby incorporated by reference. Thus one mode of practicing the current invention entails:
(a) forming a gel from a mixture comprising organic gel precursors, inorganic aerogels fillers; and
(b) drying said gel.

Another mode comprises the steps of:
(a) dispensing an amount of inorganic aerogel fillers into a solution comprising organic gel precursors, thereby forming a mixture;
(b) forming a gel from said mixture; and
(c) drying said gel.

Yet another mode comprises the steps of:
(a) mixing an amount of inorganic aerogel fillers with an amount of organic gel precursors in a suitable solvent;
(b) forming a gel from the mixture; and
(c) drying said gel.

In one aspect the fillers of the present invention are already aerogels before contacting the organic gel precursor solution. This system is therefore distinct from that of an organic/inorganic interpenetrating system where the latter does not comprise any aerogel particles prior to gelation. In another aspect the composite of the present invention comprises a substantially continuous organic aerogel network with inorganic aerogel particulates dispersed therein. As a composition, the above mentioned materials are different from hybrid aerogels where organic and inorganic components are chemically bound. They are also different from organic-inorganic interpenetrating systems in that the materials of the present invention have inorganic aerogel fillers dispersed within an organic aerogel matrix whereas in an interpenetrating network, two polymeric phases organic and inorganic respectively are interpenetrating each other. Additionally, the properties resulting from such different compositions are very different.

Generally, gels may be formed via (a) maintaining the mixture in a quiescent state for a sufficient period of time, preferably in aging solvents, (b) changing the pH of the solution, (c) addition of a catalyst, (d) directing a form of energy onto the mixture, or (e) any combination of methods (a)-(d). Exemplary forms of energy include: a controlled flux of electromagnetic (ultraviolet, visible, infrared, microwave), acoustic (ultrasound), or particle radiation.

The preferred aging solvents for use in the present invention include, but are not limited to, methanol, ethanol, propanol, toluene, methyl ethyl ketone, acetone, 4-methyl-2-pentanone, tetrahydrofuran, dichloromethane, monochlorobenzene, trichlorofluoromethane, chlorodifluoromethane, 1,1,1-trifluoro-2-fluoroethane, 1,1-dichloro-1-fluoroethane.

Suitable solvents should be non-reactive towards any of the starting materials for preparation of a gel, or the resultant gel or composite material on the whole. Essentially, the solvent should act as a solvating agent for the starting materials, but act as a non-solvent towards the formed gel. Suitable solvents for use in the present invention include hydrocarbons, dialkyl ethers, cyclic ethers, ketones, alkyl alkanoates, aliphatic and cycloaliphatic hydrofluorocarbons, hydrochlorocarbons, hydrochlorofluorocarbons, chlorofluorocarbons, halogenated aromatics and fluorine-containing ethers. Mixtures of such compounds also can be used. Other suitable solvents include aliphatic or cyclic hydrocarbons such as ethane, propane, n-butane, isobutane, n-pentane, isopentane, cyclopentane, neopentane, hexane, cyclohexane, benzene, xylene, and toluene. Suitable dialkyl ethers include compounds having from 2 to 6 carbon atoms. Examples of ether solvents include dimethyl ether, methyl ethyl ether, diethyl ether, methyl propyl ether, methyl isopropyl ether, ethyl propyl ether, ethyl isopropyl ether, dipropyl ether, propyl isopropyl ether, diisopropyl ether, methyl butyl ether, methyl isobutyl ether, methyl t-butyl ether, ethyl butyl ether, ethyl isobutyl ether and ethyl t-butyl ether. Suitable cyclic ethers include tetrahydrofuran. Examples of dialkyl ketones to be used as solvents include acetone, cyclohexanone, methyl t-butyl ketone and methyl ethyl ketone. Suitable alkyl alkanoates which may be used as solvent include methyl formate, methyl acetate, ethyl formate, butylacetate and ethyl acetate. Suitable hydrofluorocarbons which may be used as solvent include lower hydrofluoroalkanes, for example difluoromethane, 1,2-difluoroethane, 1,1,1,4,4,4-hexafluorobutane, pentafluoroethane, 1,1,1,2-tetrafluoroethane, 1,1,2,2-tetrafluoroethane, pentafluorobutane and its isomers, tetrafluoropropane and its isomers, and pentafluoropropane and its isomers. Substantially fluorinated or perfluorinated (cyclo)alkanes having 2 to 10 carbon atoms can also be used. Suitable hydrochlorofluorocarbons which may be used as solvent include chlorodifluoromethane, 1,1-dichloro-2,2,2-trifluoroethane, 1,1-dichloro-1-fluoroethane, 1-chloro-1,1-difluoroethane, 1-chloro-2-fluoroethane and 1,1,1,2-tetrafluoro-2-chloroethane. Suitable chlorofluorocarbons which may be used as solvent include trichlorofluoromethane, dichlorodifluoromethane, trichlorotrifluoroethane and tetrafluorodichloroethane. Suitable hydrochlorocarbons which may be used as solvents include 1- and 2-chloropropane and dichloromethane. Suitable halogenated aromatics include monochlorobenzene and dichlorobenzene. Suitable fluorine-containing ethers which may be used as solvents include bis-(trifluoromethyl) ether, trifluoromethyl difluoromethyl ether, methyl fluoromethyl ether, methyl trifluoromethyl ether, bis-(difluoromethyl)ether, fluoromethyl difluoromethyl ether, methyl difluoromethyl ether, bis-(fluoromethyl)ether, 2,2,2-trifluoroethyl difluoromethyl ether, pentafluoroethyl trifluoromethyl ether, pentafluoroethyl difluoromethyl ether, 1,1,2,2-tetrafluoroethyl difluoromethyl ether, 1,2,2,2-tetrafluoroethyl fluoromethyl ether, 1,2,2-trifluoroethyl difluoromethyl ether, 1,1-difluoroethyl methyl ether, 1,1,1,3,3,3-hexafluoroprop-2-yl fluoromethyl ether.

The preferred solvents include toluene, methyl ethyl ketone, acetone, tetrahydrofuran, dichloromethane, monochlorobenzene, trichlorofluoromethane, chlorodifluoromethane, 1,1,1-trifluoro-2-fluoroethane, 1,1-dichloro-1-fluoroethane. The most preferred solvents are acetone, methyl ethyl ketone, tetrahydrofuran, and toluene.

Gels may be additionally aged prior to drying to further strengthen the gel structure by increasing the number of cross-linkages. This procedure is useful for preventing potential volume loss during drying, or simply obtaining a stronger final gel. Aging can involve: maintaining the gel (prior to drying) at a quiescent state for an extended period, maintaining the gel at elevated temperatures, addition of cross-linkage promoting compounds or any combination thereof. Aging time period typically requires between about 1 hr and several days. The preferred temperatures are usually between about 10° C. and about 100° C.

The preferred aging solvents include, methanol, ethanol, propanol, toluene, methyl ethyl ketone, acetone, 4-methyl-2-pentanone, tetrahydrofuran, dichloromethane, monochlorobenzene, trichlorofluoromethane, chlorodifluoromethane, 1,1,1-trifluoro-2-fluoroethane, 1,1-dichloro-1-fluoroethane.

Drying plays an important role in engineering the porosity and density of aergoels. To date, numerous drying methods have been explored. U.S. Pat. No. 6,670,402 teaches drying via rapid solvent exchange of solvent(s) inside wet gels using supercritical CO₂ by injecting supercritical, rather than liquid, CO₂ into an extractor that has been pre-heated and pre-pressurized to substantially supercritical conditions or above to produce aerogels. U.S. Pat. No. 5,962,539 describes a process for obtaining an aerogel from a polymeric material that is in the form a sol-gel in an organic solvent, by exchanging the organic solvent for a fluid having a critical temperature below a temperature of polymer decomposition, and supercritically drying the fluid/sol-gel. U.S. Pat. No. 6,315,971 discloses processes for producing gel compositions comprising: drying a wet gel comprising gel solids and a drying agent to remove the drying agent under drying conditions sufficient to minimize shrinkage of the gel during drying. Also, U.S. Pat. No. 5,420,168 describes a process whereby Resorcinol/Formaldehyde aerogels can be manufactured using a simple air drying procedure. Finally, U.S. Pat. No. 5,565,142 herein incorporated by reference describes subcritical drying techniques. The embodiments of the present invention can be practiced with drying using any of the above techniques. In some embodiments, it is preferred that the drying is performed at vacuum to below super-critical pressures (pressures below the critical pressure of the fluid present in the gel at some point) and optionally using surface modifying agents.

In general, the organic gel precursors can comprise any monomers, oligomers, polymers or combinations thereof provided that an organic gel can be prepared using the same. Organic aerogels can be based on: isocyanates, polyisocyantes, polyurea, polyurethane, polybutadiene, polycyanurates, polyacrylates, polystyrenes, cellulose, polydicyclopentadiene, polyacrylonitriles, polyimides, polyfurfuryl alcohol, phenol furfuryl alcohol, melamine formaldehydes, resorcinol formaldehydes, cresol formaldehyde, phenol formaldehyde, phloroglucinol formaldehyde, polyvinyl alcohol dialdehyde, polyacrylamides, epoxies, agar, agarose, and the like. Following Publications describe preparation of organic aerogels. “Low-density organic aerogels by double-catalyzed synthesis”, K. Barrel; J Non-Cryst. Solids, 225, 46 (1998); and “New organic aerogels based upon a phenolic-furfural reaction” Pekala et al. J Non-Cryst. Solids, 188, 34 (1995). All of the above are hereby incorporated by reference. The preferred organic aerogels are those based on polyurea, polyurethane, polybutadiene, polycyanurates, cellulose, polydicyclopentadiene, and polyimides.

As used herein “filler” or “fillers” refer to particles of inorganic aerogels which may be based on, silica, titania, zirconia, alumina, hafnia, yttria, ceria, carbides and nitrides. Inorganic aerogels may be prepared via drying of gels formed from any of the gel-forming techniques customarily practiced in the art. Examples include the sol-gel and “water glass” process. The sol-gel technique is generally preferred where an example of such practice includes adjusting the pH and/or temperature of a dilute metal oxide sol to a point where gelation occurs (R. K. Iler, Colloid Chemistry of Silica and Silicates, 1954, chapter 6; R. K. Iler, The Chemistry of Silca, 1979, chapter 5, C. J. Brinker and G. W. Scherer, Sol-Gel Science, 1990 both hereby incorporated by reference. Examples of materials for forming inorganic aerogels are metal oxides such as silica, alumina, titania, zirconia, hafnia, ceria, yttria, vanadia and the like. Particularly preferred are gels formed primarily from alcohol solutions of hydrolyzed silicate esters due to their ready availability and low cost. Generally the principal synthetic route for the formation of an inorganic aerogel is the hydrolysis and condensation of an appropriate metal alkoxide. The most suitable metal alkoxides are those having about 1 to 6 carbon atoms, preferably from 1-4 carbon atoms, in each alkyl group. Specific examples of such compounds include tetraethoxysilane (TEOS), tetramethoxysilane (TMOS), tetra-n-propoxysilane, aluminum isopropoxide, aluminum secbutoxide, cerium isopropoxide, hafnium tert-butoxide, magnesium aluminum isopropoxide, yttrium isopro-poxide, titanium isopropoxide, zirconium isopropoxide, and the like. In the case of silica precursors, these materials can be partially hydrolyzed and stabilized at low pH as polymers of polysilicic acid esters such as polydiethoxysiloxane. Pre-polymerized silica precursors are also preferred for the aerogel composites described herein.

Inorganic aerogels may be prepared in both hydrophilic and hydrophobic forms. Both hydrophilic and hydrophobic inorganic aerogels can be used for the present invention. However, hydrophilic inorganic aerogels can easily absorb moisture or water resulting in diminished thermal insulation performance. As such, hydrophobic inorganic aerogels are preferred. Hydrophobic aerogels can be prepared by either treatment with hydrophobing agents such as organosilicon compounds, silanes, chlorosilanes or mixing organically modified hydrophobic metal alkoxides such as organotrialkoxysilanes (R′Si(OR)₃) as a co-precursor with the inorganic gel precursors. Examples of such organotrialkoxysilanes include: methyltriethoxysilane, methyltrimethoxysilane, methyltri-n-propoxysilane, phenyltriethoxysilane, and vinyltriethoxysilane. Further details may be found in the following references which are incorporated by reference here. Yokogawa et al, “Hydrophobic silica aerogels”, J Non-Cryst. Solids, 186, 23 (1995) and Schwertfeger et al., “Hydrophobic aerogels from Si(OMe)₄/MeSi(OMe)₃ mixtures”, J Non-Cryst. Solids, 145, 85 (1992).

In an embodiment, the inorganic fillers comprise fumed silica, which may or may not be combined with other aerogel fillers.

According to embodiments of the present invention, the thermal conductivity of inorganic aerogel fillers is less than about 40 mW/m K, preferably less than about 30 mW/m K, more preferably less than about 20 mW/m K and most preferably less than about 15 mW/m K. The inorganic aerogel particles for the present invention can be prepared to a preferred size and size distribution by ball mill, jet mill, bantam mill, brinkman mill, roll mill, super mixers, or other size grinding and mixing techniques available to a person of ordinary skill in the art. In order to efficiently improve thermal performance of organic aerogels for the present invention, smaller particle size of inorganic aerogel is recommended to (a) increase surface area and (b) to penetrate through fibrous structures that may also be incorporated into the organic aerogels. However, if particle size is too small, handling and/or processing problems may arise such as: low bulk density, increasing viscosity, and non-uniform dispersion into the organic gel precursor solution. Mircoparticles are preferred wherein their size (diameter) of preferably ranges from about 0.1 μm to about 100 μm, more preferably between about 0.5 μm and about 50 μm. The density of inorganic aerogel fillers for the present invention is preferably between about 0.01 g/cm³ and about 0.4 g/cm³, more preferably between 0.05 g/cm³ and 0.2 g/cm³. The inorganic aerogel fillers are preferably nanoporous wherein the pore diameter ranges between about 0.1 nm and about 200 nm, more preferably between about 1 nm to 100 nm. Thus in a further aspect, the inorganic aerogel fillers of the present invention are nanoporous materials. In a further embodiment, the pore volume of the fillers are typically greater than about 2.0 cm³/g and the surface area is generally greater than about 500 m²/g. Of course, the fillers can be in any shape including but not limited to polyhedral, substantially spherical, oblong, disc-shaped, flakes or a combination thereof. Inorganic aerogel fillers for use in the present invention can be incorporated into an organic aerogel matrix in amounts between about 1 and about 200% by weight relative to the weight of organic content of the organic aerogel. Stated differently, the weight ratio of the organic aerogel to inorganic aerogel fillers is greater than about 1:0.01 respectively. In some embodiments this ratio is greater than about 1:1. In further embodiments weight ratio is as high as 1:2.

Organic aerogels according to embodiments of the present invention can be fiber-reinforced for added mechanical performance. This can be accomplished by dispensing chopped fibers, a fibrous structure, fibrous batting, microfibers, or combination thereof into a mixture (solution) comprising organic gel precursors and inorganic aerogel fillers. Suitable fibrous structures include, but are not limited to wovens, non-wovens, mats, felts, battings and combinations thereof. Alternatively, said mixture may be transferred into a fibrous structure, with or without chopped fibers. Of course in either case, the fibrous structure may be completely or incompletely submerged in the solution comprising the precursors. Said mixture and said fibrous structure can be combined at any point prior to gel formation. In all such cases, gel formation followed by drying results in fiber-reinforced aerogel composites. Aerogel composites reinforced with a fibrous batting, herein referred to as “blankets” or “aerogel blankets”, are particularly useful for applications requiring flexibility since they are highly conformable and provide excellent thermal conductivity. Aerogel blankets and fiber-reinforced aerogel composites that would benefit from several embodiments of the present invention are described in U.S. Pat. Nos. 7,078,359, 6,068,882, 5,789,075, 5,306,555, 6,887,563, and 6,080,475, all hereby incorporated by reference, in their entirety. This is a non-exhaustive list and any aerogel based material may make use of the embodiments of the present invention to improve its performance.

Accordingly, a mode of preparing fiber-reinforced aerogel composites comprises the steps of:
(a) dispensing a mixture comprising inorganic aerogel fillers and organic gel precursors, into a fibrous structure;
(b) forming a gel from said mixture; and
(c) drying the gel.
   Another method comprises the steps of:
(a) dispensing an organic gel precursor solution into an amount of inorganic aerogel fillers, thereby forming a mixture;
(b) introducing a fibrous structure into said mixture;
(c) forming a gel from said mixture; and
(d) drying the gel.
   Another method comprises the steps of:
(a) dispensing an amount of inorganic aerogel fillers into an organic gel precursor solution, thereby forming a mixture;
(b) introducing the mixture into a fibrous structure;
(c) forming a gel from said mixture; and
(d) drying the gel.
   Yet another method comprises the steps of:
(a) dispensing an organic gel precursor solution, into a fibrous structure;
(b) dispensing an amount of inorganic aerogel fillers into the organic gel precursor solution;
(c) forming a gel from said solution; and
(d) drying the gel.
   Still, another method comprises the steps of:
(a) dispensing an amount of inorganic aerogel fillers into a fibrous structure;
(b) introducing an organic gel precursor solution into said fibrous structure;
(c) forming a gel from said solution; and
(d) drying the gel.

For optimal thermal performance, aerogels can be opacified to reduce the radiative component of heat transfer. At any point prior to gel formation, opacifying compounds may be dispersed into the mixture comprising gel precursors. Examples of opacifying compounds include and are not limited to: B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or mixtures thereof.

Preservation of pore structure of the organic gels during removal of the solvents from said pores under supercritical conditions is of concern to this invention. During a fast supercritical drying process the gel can shrink substantially, leading to an increase in density of the final aerogel. In preferred embodiments, reinforcing inorganic and/or organic additives are added to the above mixture in order to moderate shrinkage and densification.

### DETAILED DESCRIPTION OF THE PREFERRED EMBODIMENTS

In preferred embodiments of the present invention the organic aerogel comprises an isocyanate or polyisocyanate-based polymer. Accordingly, a mode of practice comprises the steps of:
(a) forming a gel from a mixture comprising:
   an isocyanate or a polyisocyanate, and
   an inorganic aerogel filler;
(b) forming a gel from said mixture; and
(c) drying the gel.
   Another mode involves the steps of:
(a) mixing an isocyanate or a polyisocyanate with an inorganic aerogel filler in a suitable solvent;
(b) forming a gel from the mixture; and
(c) drying the gel.

The mixtures may further comprise a catalyst, a fibrous structure, opacifiers, other (non-aerogel) additives or a combination thereof. Preferably the gels are aged at an elevated temperature prior to drying as previously prescribed. Further it is preferable that the gels are dried with a supercritical fluid.

In a preferred embodiment, the organic aerogel is based on polyurea. Polyurea describes a product formed from the reaction of a compound comprising isocyanate group(s) with another comprising an amine group(s). As such, the gel precursors for forming polyurea-based gels, and corresponding aerogels, comprise an isocyanate-containing precursor and an amine-containing precursor. More preferably, polyisocyanate and polyamine precursors are used. Accordingly, another method of practicing the current invention comprises the steps of:
(a) forming a gel from a mixture comprising:
   at least one isocyanate or polyisocyanate,
   at least one polyamine and
   an inorganic aerogel filler; and
(b) drying the gel

The polyamines may be selected from polyoxyalkyleneamines, amine based polyols, or the mixture of thereof. Suitable polyamines include but are not limited to: polyoxyalkyleneamines such as polyoxyethylene-propylenemonoamines, polyoxypropylenediamines, and polyoxypropylenetriamines. The average molecular weight of the polyoxyalkyleneamines is preferably larger than 50, more preferably larger than 150. The preferred amine hydrogen equivalent weight (AHEW) is larger than 50. Examples of polyoxyalkyleneamines that are commercially available, include but are not limited to: Jeffamine® D-230, Jeffamine® T-403, Jeffamine® D-400, Jeffamine M-2005 (XTJ-507), Jeffamine® D-2000, Jeffamine® D-4000 (XTJ-510), Jeffamine® T-3000 (XTJ-509), and Jeffamine® T-5000 (all available from Huntsman Corp.).

Isocyanates or polyisocyanates suitable for use include aliphatic, cycloaliphatic, araliphatic, heterocyclic and aromatic diisocyanates such as those which are described in U.S. Pat. No. 6,150,489 and “Justus Liebigs Annalen der Chemie 562”, pages 75-136 both hereby incorporated by reference. Preferred isocyantes or polyisocyanates include but are not limited to: aliphatic diisocyanates such as 1,6-hexamethylene diisocyanate, cycloaliphatic diisocyanates such as isophorone diisocyanate, 1,4-cyclohexane-diisocyanate, 1-methyl-2,4-cyclohexane diisocyanate, 1-methyl-2,6-cyclohexane diisocyanate and corresponding mixtures of isomers; 4,4′-dicyclohexylmethane diisocyanate, 2,4′-dicyclohexylmethane diisocyanate, 2,2′-dicyclohexylmethane diisocyanate and corresponding mixtures of isomers, and aromatic diisocyanates such as toluene 2,4-diisocyanate (TDI), mixtures of toluene 2,4-diisocyanate and toluene 2,6-diisocyanate, 4,4′-diphenylmethane diisocyanate (MDI), 2,4′-diphenylmethane diisocyanate and 2,2′-diphenylmethane diisocyanate; mixtures of 2,4′-diphenylmethane diisocyanate and 4,4′-diphenylmethane diisocyanate, urethane-modified liquid 4,4′-diphenylmethane diisocyanates and 2,4′-di-phenylmethane diisocyanates, 4,4′-diisocyanato-diphenylethane-(1,2) and 1,5-naphthylene diisocyanate, and isocyanate such as triphenylmethane 4,4′,4″-triisocyanate or polymethylene polyphenylene isocyanates (polymeric MDI) having an isocyanate functionality of greater than 2 and the so-called MDI variants (MDI modified by the introduction of urethane, allophanate, urea, biuret, carbodiimide, uretonimine or isocyanurate residues). Of particular importance are aromatic isocyanate resins such as TDI and the corresponding isomeric mixtures, MDI and the corresponding isomeric mixtures, and polymeric MDI. These isocyanate resins are commercially available from many companies such as Bayer, Dow, BASF, Huntsman, Imperial, Lyondell, Shell, and Degussa.

At least one isocyanate or polyisocyanate resin is used in amounts ranging from about 0.5 to about 40% by weight depending on the theoretical target density, preferably from about 1 to about 35% by weight, and more preferably from about 2 to about 30% by weight based on the weight of total reaction mixture.

The polyamines are used at specific ratios between functional groups in the polyoxyalkyleneamines (—NH₂) and functional groups in the polyisocyanate resin (NCO). This specific ratio of functional groups between polyamine and the polyisocyanate is very relevant in determining thermal and physical properties of the final polyurea aerogels. If polyamine is used more than the preferred amount, either a very soft xerogel results due to phase separation or no gel occurs. The preferred ratio between functional groups in the polyamine (NH₂) and functional groups in the polyisocyanate resin (NCO) is between about 0.01:1 and about 1:1, and more preferably between about 0.05:1 and about 0.6:1.

The preferred solvents include toluene, methyl ethyl ketone, acetone, tetrahydrofuran, dichloromethane, monochlorobenzene, trichlorofluoromethane, chlorodifluoromethane, 1,1,1-trifluoro-2-fluoroethane, 1,1-dichloro-1-fluoroethane. The most preferred solvents are acetone, methyl ethyl ketone, tetrahydrofuran, and toluene.

The solvent amount for use depends on the desired density and additives used (such as opacifiers and reinforcement material). The nature and amount of solvent that can be used may be based on the theoretical (or target) density while considering that the final density is generally higher than the theoretical density typically due to shrinkages occurring during aging and/or supercritical drying steps. The solvent amount for use in the present invention is preferably in such an amount that the target density of aerogel ranges from about 0.01 g/cm³ to about 0.5 g/cm³, and more preferably from about 0.03 g/cm³ to about 0.4 g/cm³.

Another embodiment of the present invention involves the steps of
(b) forming a gel from a mixture comprising:
   at least one isocyanate or polyisocyanate,
   at least one polyamine,
   at least one catalyst and
   an inorganic aerogel filler; and
(b) drying the gel

The preferable catalysts for use in the present invention include those able to promote polyurea formation which include but are not limited to: certain aliphatic and aromatic primary, secondary and tertiary amines; long chain alkylamide compounds, such as ethylamine, 1-benzofuran-2-amine, 4-quinolylamine, [1,1′-binaphthalene-3,3′,4,4′-tetrayl]tetraamine, p-aminobenzoic acid, dimethylamine, N-methylethanamine, diethylamine, N-methylisopropylamine, N-isopropylcyclobutanamine, N,2-dimethyl-3-pentanamine, N,N-dimethylethanamine, N-methyldiethanamine, N-ethyl-N-methyl-3-hexanamine, commercially available didecylmethylamine (DAMA-1010 amine, tertiary amine of 98.9 wt %, available from Albemarl Corporation); and organometallic compounds, especially tin compounds such as stannous octoate and dibutyltin dilaurate, alkali metal salts, especially, commercially available from Atofina Chemicals, Inc., stannous bis(2-Ethylhexoate) (FASCAT 2003), dibutyltin diacetate (FASCAT 4200), and dibutyltin dilaurate (FASCAT 4202). Other catalysts include any isocyanate trimerisation catalyst such as quaternary ammonium hydroxides, alkali metal and alkaline earth metal hydroxides, alkoxides and carboxylates, for example potassium acetate and potassium 2-ethylhexoate, non-basic metal carboxylates, for example lead octoate, and symmetrical triazine derivatives. Commercially available preferred trimerisation catalysts for use in the present method are Tris(dimethylaminopropyl)hexahydrotriazin (Polycat 41) and N-hydroxypropyltrimethyl ammonium-2-ethylhexanoate (DABCO TMR)₂-hydroxypropyl trimethylammonium formate (DABCO TMR-2), and N-hydroxy-alkyl quarternary ammonium carboxylate (DABCO TMR-4) available from Air Products. Other preferable catalysts are triethylamine, triethanolamine diphenylamine, didecylmethylamine (DAMA-1010), stannous bis (2-Ethylhexoate) (FASCAT 2003), dibutyltin diacetate (FASCAT 4202), tris(dimethylaminopropyl)hexahydrotriazin (Polycat 41), and N-hydroxypropyltrimethyl ammonium-2-ethylhexanoate (DABCO TMR).

The amount of catalyst useful in the present invention depends on the desired gel time, the amount of polyisocyanate and polyamine, reaction temperature, solvent type, and amount of additives incorporated (if any). The catalyst amount is preferably used in such an amount that the ratio between the total weight of catalyst and polyisocyanate and polyamine is between about 0:1 (0 wt % catalyst) and about 0.2:1 (20 wt % catalyst), preferably between about 0.001:1 (0.1 wt % catalyst) and about 0.1:1 (10 wt % catalyst).

In order to further improve thermal and mechanical properties, structural integrity, and the handling of the aerogels, IR opacifiers and/or reinforcement additives can be incorporated in during the sol-gel process, preferably in an amount of between about 0.05 and about 50% by weight based on the weight of solid content of organic polymer system. Examples of suitable IR opacifiers and reinforcement additives include carbon black (solution), carbon fiber, boron fiber, ceramic fiber, rayon fiber, nylon fiber, olefin fiber, alumina fiber, asbestos fiber, zirconia fiber, alumina, clay, mica, silicas, calcium carbonate, titanium dioxide, talc, zinc oxide, barium sulfates, and wood.

In an embodiment, preparation of an aerogel blanket involves placing a fiber batting at the bottom and/or top of the mold in which the gel is subsequently cast. Alternately, all the materials in a sol or slurry form can be introduced into a fibrous batting and allowed to gel. Examples of such a fiber batting include: polyester fibers, polyolefin terephthalates, poly(ethylene) naphthalate, polycarbonates and Rayon, Nylon, cotton-based lycra (manufactured by DuPont), carbon-based fibers such as graphite, carbon fiber precursors such as: polyacrylonitrile (PAN), oxidized PAN, uncarbonized heat-treated PAN (such as the one manufactured by SGL carbon); fiberglass based material like S-glass, 901 glass, 902 glass, 475 glass, E-glass, quartz, Quartzel® (manufactured by Saint-Gobain), Q-felt® (manufactured by Johns Manville), alumina fibers like Saffil® (manufactured by Saffil), Durablanket® (manufactured by Unifrax), polyaramid fibers such as Kevlar®, Nomex®, Sontera® (all manufactured by DuPont), Conex® (manufactured by Teijin), polyolefins such as Tyvek® (manufactured by DuPont), Dyneema® (manufactured by DSM), Spectra® (manufactured by Honeywell), polypropylene fibers like Typar® and Xavan® (both manufactured by DuPont), fluoropolymers like PTFE with trade names such as Teflon (manufactured by DuPont), Goretex® (manufactured by GORE), silicon carbide fibers such as Nicalon® (manufactured by COI Ceramics), Nextel® fibers (manufactured by 3M), acrylic fibers, fibers of wool, silk, hemp, leather, suede, PBO-Zylon fibers (manufactured by Tyobo), liquid crystal material like Vectan® (manufactured by Hoechst), Cambrelle fibers (manufactured by DuPont), polyurethanes, polyamides, wood fibers, and boron, aluminum, iron, stainless steel fibers, and thermoplastics like PEEK, PES, PEI, PEK, and PPS.

In presence of oxygen and high temperatures organic aerogels can undergo oxidation. Antioxidants can be incorporated into the organic aerogel structure to counter this effect. Antioxidants can be incorporated in the sol-gel process, preferably in an amount of between 0.1 and 20% by weight based on the solid weight of organic aerogel system. Examples of suitable antioxidant materials include phenol-based compounds or phosphorus-based compounds. The commonly known general-purpose phenol-based compound antioxidants, especially commercially available material such as Irganox® 259, Irganox® 1010, or Irganox® 1076 (manufactured by Ciba Specialty Chemicals, Inc) can be used herein. The phosphorus-based compounds are exemplified, by the material commercially available under the trademark Ultranox® 626, Ultranox® 641, or Ultranox® 668 (manufactured by GE Specialty Chemicals). They may be used alone or in combinations of two or more.

A specific mode of practicing the preferred embodiments is as follows: A mixture is prepared by mixing at least one polyisocyanate and at least one polyamine in a solvent. Optionally, a catalyst is added to the mixture. Alternately, the polyisocyanate resin is dissolved in a portion of the solvent, and the polyamine separate portion of the solvent before combining the two. Optionally a solution of the catalyst in a residual amount of solvent is added to the mixture. Mixing can be done at room temperature or at a somewhat higher temperature that is below the boiling temperature of solvent(s) used. The inorganic aerogel fillers may be added to the organic gel precursors at any point prior to gel formation. Gel formation may be viewed as the point where a solution (or mixture) exhibits resistance to flow and/or forms a continuous polymeric network throughout its volume. Therefore the mixture comprising inorganic aerogel fillers and organic precursors should be conducive to gel formation.

The solids content of the gel precursor mixture is preferably between 1 and 45% by weight, and more preferably between 3 and 40% by weight. Thereafter, the mixture is left standing for a certain period of time to form a gel. This time period typically varies from 30 seconds to several days, even weeks and months, depending on the types of ingredients, the ratio between functional groups in the polyisocyante and in the polyamine, catalyst content, and the target density. The gelation time is preferably between 30 second and 6 hours. The more preferable time to form a polymeric gel ranges from 1 minute to 2 hours. Temperatures in the range of from about −10° C. to about 80° C., preferably 10° C. to 60° C. may be employed in gelation.

In order to form a more uniform gel, it is recommended to stabilize the gels at room temperature for a short period so that handling is easier during subsequent processing. This step is important in processing weaker gels with lower target density. The typical period for this process varies from 5 minutes to 20 hours at room temperature, more typically between 20 minutes and 2 hours.

Although the mixture gels within a few seconds, a few minutes, or a few hours, it has been found advantageous to age (post-cure) the wet gels at elevated temperatures for a period of time so as to obtain a stronger gel which can be easily handled during subsequent processing. Aging at a higher temperature reduces the time needed to obtain a stronger gel. Therefore, the wet gels can be aged at elevated temperatures for a certain period of time until the weak polymeric wet gel becomes strengthened. This aging process is especially required in processing weaker gels with lower target density. The preferable aging time period for use in the present invention varies from 1 hour to several days, more preferably, ranges from 2 hours to 48 hrs. Aging temperatures can range from 10° C. to 100° C., preferably from 20° C. to 80° C. and are preferably below the boiling temperature of solvent(s) used for gelation and aging. Aging solvents for the preferred embodiments include, but are not limited to: methanol, ethanol, propanol, toluene, methyl ethyl ketone, acetone, 4-methyl-2-pentanone, tetrahydrofuran, dichloromethane, monochlorobenzene, trichlorofluoromethane, chlorodifluoromethane, 1,1,1-trifluoro-2-fluoroethane, 1,1-dichloro-1-fluoroethane. Preferably the aging solvent volume is such that the solvent forms a layer over the wet gel surface. Optionally, the aging solution can contain hydrophobic agents to improve the hydrophobicity and catalysts to promote the post curing depending on the organic polymer aerogel system. Also, optionally, the aged wet gel can be washed with fresh solvent after aging process and before supercritical drying.

The theoretical (or target) densities of organic aerogels reinforced with inorganic aerogel fillers are provided by the solid content of the reaction mixture and the amount of solvent for the present invention depending on amount of inorganic aerogel fillers and additives used (such as opacifiers and reinforcement material). The preferable target density ranges from 0.01 g/cm³ to 0.4 g/cm³, and more preferably from 0.02 g/cm³ to 0.3 g/cm³. However, the final density is generally higher than the theoretical target density, due to shrinkage of organic aerogels during the aging and supercritical drying steps. The preferred final density of organic polymer based aerogels comprising inorganic aerogel fillers ranges from about 0.01 g/cm³ to about 0.5 g/cm³, and more preferably from about 0.02 g/cm³ to about 0.4 g/cm³.

The preferred drying route is via supercritical drying. The supercritical drying includes placing the solvent-filled wet gel containing inorganic aerogel fillers and other additives in a temperature-controlled pressure vessel and bringing the vessel to a pressure above the critical pressure of CO₂ by filling with CO₂ gas or liquid CO₂. In another embodiment, before the supercritical drying step, the solvent in the wet gel can be exchanged with liquid carbon dioxide and subsequently dried under supercritical CO₂. Modifiers can be added to the carbon dioxide to make the gels more suitable for supercritical drying. At that point the vessel is then heated above the critical temperature of the CO₂. After a few hours the pressure is slowly released from the vessel while keeping a constant temperature. After the vessel cools down and is at atmospheric pressure, dried the microporous organic polymer aerogel monoliths and composites reinforced with inorganic aerogel fillers are removed from the vessel.

As per the embodiments of the present invention, organic aerogels comprising inorganic aerogel fillers, along with their fiber-reinforced versions generally exhibit pore sizes in the range 1 to 100 nm, as obtained by the Brunauer-Emmet-Teller (BET) nitrogen adsorption method. BET surface areas of the aerogels prepared according to the process of the present invention are generally in the range 0.1 to 500 m²/g. The thermal conductivities are typically less than about 40 mW/m K, preferably, less than about 30 mW/mK and most preferably less than about 20 mW/mK.

In another embodiment, low density materials such as perlite may be combined with inorganic aerogel fillers and incorporated into organic aerogels. Alternatively, perlite may be incorporated into aerogel matrix (organic or inorganic matrix) to make aerogel composites. Perlite is an amorphous volcanic glass that has a relatively high water content. It occurs naturally and has the unusual property of greatly expanding when heated sufficiently. When it reaches temperatures of 850-900° C., perlite softens (since it is a glass). Water trapped in the structure of the material escapes and vaporises and this causes the expansion of the material to 7-16 times its original volume. The expanded material is a brilliant white, due to the reflectivity of the trapped bubbles. Both expanded and unexpanded perlite may be incorporated into aerogel matrices. Unexpanded (“raw”) perlite bulk density: around 1100 kg/m³ (1.1 g/cm³). Typical expanded perlite bulk density: 30-150 kg/m³

Alternatively, cellular glass materials may be incorporated into aerogel matrices (organic or inorganic). Representative cellular glass materials include materials sold under the trade name FOAMGLAS by Pittsburgh Corning Corporation.

The potential applications for the organic aerogel composites and fiber-reinforced forms described herein include, but are not limited to, thermal and acoustic insulation, radiation shielding and vibrational damping materials. Other areas of use include aerospace, military, and commercial applications that require a good thermal insulation performance. Other examples include space suits, gloves, footwear, helmets, systems for warming, storing, and/or transporting food and medicine, sleeping bags and pads, military and recreational cloth and tents. Because of their excellent thermal insulation performance, microporous structure, and large surface area, other applications of the present invention include: catalyst supports, selectively permeable membranes, sensors, packing materials, aircraft insulation, cryogenic tank liners, liquefied gas transport, etc. Further benefits include uses as recyclables used as impact modifiers and/or filler materials for conventional plastics. As the aerogel composites of the present invention provide excellent thermal insulation properties, they can be used in any place where conventional insulation such as fiber glass, mineral wool, polyurethane foam, polyisocyanurate foam, polyimide foam, vacuum or any other known insulation are currently used. Additionally, where there is a space limitation, aerogel composites by the virtue of their high insulation performance may be well suited. Aerogel composites may also be laminated, encapsulated or sandwiched with appropriate materials for better handing. Polymeric films, metallic films, metalized polymeric films or similar materials may be useful in laminating, encapsulating or sandwiching aerogel composites. The aerogel composite itself may be made load-bearing or additional materials may be incorporated in the aerogel to prepare a structure that may be load bearing. The levels of load that need to be supported by the aerogel composite or said structures may be widely varied by the choice of additional materials used along with the aerogel composites of the present invention.

### DESCRIPTION OF THE FIGURES

FIG. 1 demonstrates thermal conductivity improvement in an organic aerogels (polyurea) as a function of the ratio of inorganic aerogel filler to the organic aerogel content by weight for a polyurea aerogel target density of 0.06 g/cm³.

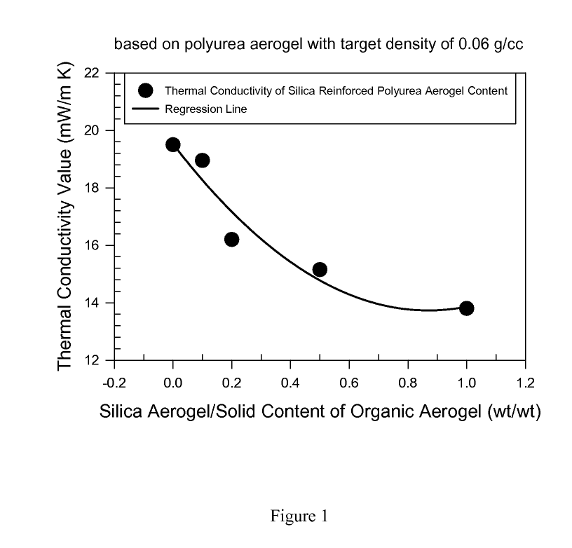

FIG. 2 demonstrates thermal conductivity improvement in polyurea aerogels as a function of the ratio of inorganic aerogel filler to the organic aerogel content by weight for a polyurea aerogel target density of 0.1 g/cm³.

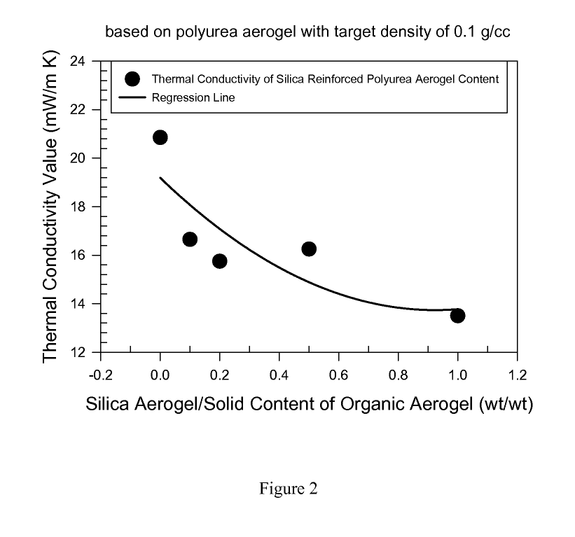

The following examples are presented to further aid in illustrating certain embodiments of the present invention and therefore may not serve to limit the scope of the invention as a whole in any manner.

### Materials

PAPI 94: a polymeric MDI of polymethylene polyphenylisocyanate containing MDI available from DOW Chemical Company, Inc., having isocyanate equivalent weight of 131.5, NCO content by weight of 32%, functionality of 2.3, and the number average molecular weight of about 290.

Jeffamine T-3000: polyoxypropylenediamine (Trifunctional primary amine) available from Huntsman Corporation, having an amine hydrogen equivalent weight of about 500, total amine of 0.94 meq/g, and the average molecular weight of about 3,000.

Triethylamine: a tertiary amine catalyst available from Aldrich.

Acetone: A.C.S. reagent grade available from Aldrich

Polysilicate: silica precursor, the partially hydrolyzed and stabilized polymer solution of polysilicic acid esters at low pH in alcohol, available from Silbond Corporation.

Ammonium hydroxide (NH₄OH): A.C.S. reagent grade containing about 29% ammonia aqueous solution, available from Aldrich.

Hexamethyldisilazane (HMDS): A.C.S. reagent grade available from Aldrich.

Ethanol: A.C.S. reagent grade available from Aldrich

### EXAMPLE 1

In order to prepare the polyurea based organic polymer aerogel containing no silica aerogel fillers, the isocyanate solution was prepared. First, 5.38 g of poly-MDI was weighed into a polypropylene container with a screw cap. Subsequently 117.54 ml of acetone was added and the mixture was stirred to obtain a homogeneous solution. 2.05 g of Jeffamine T-3000 polyamine was added to this mixture and blended until a homogeneous solution was obtained. To this solution 5.11 ml of TEA catalyst solution diluted in ethanol (10/90 wt/wt) was incorporated. After stirring thoroughly to ensure a homogeneous dispersion of the catalyst through the mixture for 1 min, the time to gelation was recorded. Some of the sol was poured into a plastic container containing quartz fiber batting in order to prepare fiber-reinforced samples as well. Containers for the monolith and composite were closed and sealed to prevent evaporation and the contents were maintained in a quiescent condition to form a polymeric gel. After waiting 30 min to ensure the uniform gelation of the mixture, acetone was added into the container in an amount to cover the gel surface. In this way, collapse of the pore structure due to evaporation of solvent out of the gel was avoided. The wet gels were aged in an oven preset at 50° C. for 20 hrs.

Once the aging process was completed and samples were cooled, the wet gel was loaded into a pressure vessel having a volume of 60 L. After closure of the vessel, liquid CO₂ at about 10° C. was introduced through a valve at the top of the vessel, and pressure was built up to 1500 psig over 10 minutes. Then the acetone was exchanged for liquid carbon dioxide and the mixture of CO₂ and acetone was withdrawn through a pressure relief system that maintains the pressure inside the vessel at 1500 psig; the mixture CO₂ and acetone was decompressed and reheated in separators where gaseous CO₂ and acetone were withdrawn, CO₂ being recycled through liquefaction and pumping, as commonly practiced in supercritical fluid extraction. When little acetone remained, the pressure vessel was heated up 50° C. for 50 minutes until the supercritical condition of the CO₂ was reached. After supercritically drying the sample for 1 hr, the pressure was slowly released from the vessel for a period of 90 min or until atmospheric conditions were reached. The dried aerogel was removed from the vessel.

The resulting polyurea based organic polymer aerogel was opaque and had a slightly yellow color due to the color of the poly-MDI resins. Density of the obtained aerogel monolith was 0.0912 g/cm³, which means the shrinkage factor (final dried density/target density) was about 1.52. The thermal conductivity coefficient of the polyurea aerogel composite was 19.5 mW/m K. The pore structure of the obtained aerogel was characterized by using BET measurements. Results on the first polyurea based aerogel revealed a surface area of 250 m²/g, pore volume of 0.58 g/cm³, and an average nanopore diameter of 13.5 nm. A quartz fiber-reinforced polyurea based aerogel composite of this example showed a density of 0.087 g/cm³, which means the shrinkage factor (final dried density/target density) was about 1.45 and a thermal conductivity of 19.2 mW/m K.

### EXAMPLE 2

The silica aerogel was first prepared using previously described techniques. 34.76 mL of an ethylpolysilicate solution was weighed into a polypropylene container with a screw cap. Subsequently, 69.62 mL of ethanol was added and the mixture was stirred to obtain a homogeneous solution. Next, 15.60 mL of water was added to the solution and blended thoroughly for 30 min. To this, 10 mL of ammonia solution diluted in ethanol (10/90 wt/wt) was added dropwise. After stirring thoroughly for 1 min, a timer was started to obtain the gel time. The silica sol was poured into plastic containers to prepare monoliths. Containers for the monolith were closed and sealed to prevent evaporation and the contents were maintained in a quiescent condition to form a polymeric silica wet gel. After waiting further 30 min to ensure uniform gelation of the mixture, dilute hexamethyldisilazane/ethanol solution (5/95 v/v, HMDS against ethanol) was added into polymeric gel in an amount to form solution layer that covers all gel surfaces in order to provide silica aerogel with the hydrophobic surface and to avoid collapse of pore structure due to evaporation of solvent. The wet gels were aged in an oven preset at 60° C. for 12 hours.

Once the aging process was completed and samples were cooled down, the wet gel was washed with fresh ethanol to remove any remaining monomers and impurities formed during the aging process. Next, the wet gel monolith samples were loaded into a pressure vessel and supercritically dried using the same method as described in example 1. After supercritically drying the sample, the dried almost transparent silica aerogel was removed from the vessel.

The resulting silica aerogel was transparent and had a slightly blue color due to the Rayleigh light scattering effect of silica aerogel. Density of the monolithic silica aerogel was 0.086 g/cm³, which means the shrinkage factor (final dried density/target density) is about 1.72. The pore structure of the obtained gel was characterized by using Brunauer-Emmet-Teller nitrogen adsorption (BET) measurements revealed a surface area of 845 m²/g, pore volume of 2.68 g/cm³, and an average nanopore diameter of 12.5 nm. Thermal conductivity coefficient of silica aerogel monoliths measured at a single temperature in the air at atmospheric pressure was 11.0 mW/m K. The obtained transparent silica aerogel was ground into fine powder or particles with the median particle size of about 5 μm using a laboratory mixer.

Next, the isocyanate solution was prepared. First, 5.38 g of poly-MDI was weighed into a polypropylene container with a screw cap. Subsequently 117.54 ml of acetone was added and the mixture was stirred to obtain a homogeneous solution. Next, 0.743 g of the silica aerogel powder prepared above was added slowly to this mixture and blended until a homogeneous solution was obtained. 2.05 g of Jeffamine T-3000 polyamine was added to this mixture and blended until a homogeneous solution was obtained. To this solution 5.11 ml of TEA catalyst solution diluted in ethanol (10/90 wt/wt) was incorporated. After blending the solution for 1 min, the same method as described in example 1 was used for the gelation and aging steps.

Once the aging process was completed and samples were cooled, the wet gel monolith samples were loaded into a pressure vessel and supercritically dried using the same method as described in example 1.

The resulting polyurea based aerogels reinforced with silica aerogel fillers were opaque and had a slightly yellow color due to the color of the poly-MDI resins. Density of the obtained polyurea based aerogel monolith reinforced with silica aerogel was 0.0907 g/cm³ (shrinkage factor of about 1.37). The pore structure of the obtained aerogel was characterized by using BET measurements. Results on the first polyurea based aerogel monolith reinforced with silica aerogel fillers revealed a surface area of 280 m²/g, pore volume of 0.61 g/cm³, and an average nanopore diameter of 13.0 nm. The thermal conductivity coefficient of the first polyurea aerogel monolith reinforced with silica aerogel particles measured at a single temperature in air at atmospheric pressure was 18.9 mW/m K. A quartz fiber batting composite of this example showed a density of 0.0894 g/cm³ (shrinkage factor of about 1.35) and a thermal conductivity of the polyurea aerogel composite with silica aerogel fine particles was 19.0 mW/m K.

### EXAMPLE 3

The isocyanate solution was prepared. First, 5.38 g of poly-MDI was weighed into a polypropylene container with a screw cap. Subsequently 117.54 ml of acetone was added and the mixture was stirred to obtain a homogeneous solution. Next, 1.49 g of the silica aerogel powder prepared above were added slowly to this mixture and blended until a homogeneous solution was obtained. 2.05 g of Jeffamine T-3000 polyamine was added to this mixture and blended until a homogeneous solution was obtained. To this solution 5.11 ml of TEA catalyst solution diluted in ethanol (10/90 wt/wt) was incorporated. After blending the solution for 1 min, the same method as described in Example 1 was used for the gelation and aging steps.

Once the aging process was completed, the wet gel was loaded into a pressure vessel and supercritically dried using the same method as described in example 1. The resulting polyurea based aerogels reinforced with silica aerogel fillers were opaque and had slightly yellow colors due to the color of the poly-MDI resins. Density of the obtained aerogel monolith was 0.0948 g/cm³ (shrinkage factor of about 1.31). The pore structure of the obtained gel was characterized by using BET measurements. Results on the polyurea based aerogels reinforced with silica aerogel revealed a surface area of 290 m²/g, pore volume of 0.65 g/cm³, and an average nanopore diameter of 12.5 nm. The thermal conductivity coefficient of the polyurea aerogel monolith reinforced with silica aerogel fine particles measured at a single temperature in air at atmospheric pressure was 16.2 mW/m K. A quartz fiber batting composite of this example showed a density of 0.0934 g/cm³ (shrinkage factor of about 1.29) and a thermal conductivity coefficient of 16.0 mW/m K.

### EXAMPLE 4

The isocyanate solution was prepared. First, 5.38 g of poly-MDI was weighed into a polypropylene container with a screw cap. Subsequently 117.54 ml of acetone was added and the mixture was stirred to obtain a homogeneous solution. Next, 3.72 g of the silica aerogel powder prepared above were added slowly to this mixture and blended until a homogeneous solution was obtained. 2.05 g of Jeffamine T-3000 polyamine was added to this mixture and blended until a homogeneous solution was obtained. To this solution 5.11 ml of TEA catalyst solution diluted in ethanol (10/90 wt/wt) was incorporated. After blending the solution for 1 min, the same method as described in Example 1 was used for the gelation and aging steps.

Once the aging process was completed, the wet gel was loaded into a pressure vessel and was subsequently supercritically dried using the same method as described in example 1. The resulting polyurea based aerogels reinforced with silica aerogel were opaque and less yellow than those of examples 1-3 due to the color of silica aerogel particle. Density of the obtained aerogel monolith was 0.1131 g/cm³ (shrinkage factor of about 1.24). The pore structure of the obtained gel was characterized by using BET measurements. Results on the polyurea based aerogel reinforced with silica aerogel fillers revealed a surface area of 350 m²/g, pore volume of 0.72 g/cm³, and an average nanopore diameter of 11.0 nm. The thermal conductivity coefficient of the polyurea aerogel monolith reinforced with silica aerogel fine particles measured at a single temperature in air at atmospheric pressure was 15.2 mW/m K. A quartz fiber batting composite of this example showed a density of 0.1104 g/cm³ (shrinkage factor of 1.21) and a thermal conductivity coefficient of 15.2 mW/m K.

### EXAMPLE 5

The isocyanate solution was prepared. First, 5.38 g of poly-MDI was weighed into a polypropylene container with a screw cap. Subsequently 117.54 ml of acetone was added and the mixture was stirred to obtain a homogeneous solution. Next, 7.43 g of the silica aerogel powder prepared above was added slowly to this mixture and blended until a homogeneous solution was obtained. 2.05 g of Jeffamine T-3000 polyamine was added to this mixture and blended until a homogeneous solution was obtained. To this solution 5.11 ml of TEA catalyst solution diluted in ethanol (10/90 wt/wt) was incorporated. After blending the solution for 1 min, the same method as described in Example 1 was used for the gelation and aging steps.

Once the aging process was completed, the wet gel was loaded into a pressure vessel and was subsequently supercritically dried using the same method as described in example 1. The resulting polyurea based aerogels reinforced with silica aerogel was opaque and much less yellow than those of examples 1-4 due to the color of silica aerogel particle. Density of the obtained aerogel monolith was 0.1451 g/cm³ (shrinkage factor of about 1.18). The relatively lower shrinkage of this sample containing more silica aerogel particles than experiment 1-4 resulted from the filler effect of inorganic silica aerogel particles on the shrinkage. The pore structure of the obtained aerogel was characterized by using BET measurements. Results on the polyurea based aerogel reinforced with silica aerogel fillers revealed a surface area of 430 m²/g, pore volume of 0.88 g/cm³, and an average nanopore diameter of 11.0 nm. The thermal conductivity coefficient of the polyurea aerogel monolith reinforced with silica aerogel fine particles measured at a single temperature in air at atmospheric pressure was 13.8 mW/m K. A quartz fiber batting composite of this example showed a density of 0.1427 g/cm³ (shrinkage factor of 1.16) and a thermal conductivity coefficient of 14.0 mW/m K.

### EXAMPLE 6

The polyurea based organic polymer aerogel containing no inorganic silica aerogel fillers was first prepared. In order to prepare the isocyanate solution, 8.95 g of poly-MDI was weighed into a polypropylene container with a screw cap. Subsequently 109.26 ml of acetone was added and the mixture was stirred to obtain a homogeneous solution. 3.41 g of Jeffamine T-3000 polyamine was added to this mixture and blended until a homogeneous solution was obtained. To this solution 8.51 ml of TEA catalyst solution diluted in ethanol (10/90 wt/wt) was incorporated. After blending the solution for 1 min, the same method as described in Example 1 was used for the gelation and aging steps.

Once the aging process was completed, the wet gel was loaded into a pressure vessel and was subsequently supercritically dried using the same method as described in example 1. The resulting polyurea based organic polymer aerogel was opaque and had a slightly yellow color due to the color of the poly-MDI resins. Density of the obtained aerogel monolith was 0.152 g/cm³, which means the shrinkage factor (final dried density/target density) was about 1.52 and a thermal conductivity coefficient of the polyurea aerogel composite was 20.9 mW/m K. The pore structure of the obtained aerogel was characterized by using BET measurements. Results on the polyurea based aerogel revealed a surface area of 280 m²/g, pore volume of 0.65 g/cm³, and an average nanopore diameter of 11.5 nm. A quartz fiber-reinforced polyurea based aerogel monolith of this example showed a density of 0.145 g/cm³, which means the shrinkage factor (final dried density/target density) was about 1.45 and a thermal conductivity coefficient of the polyurea aerogel composite was 21.2 mW/m K.

### EXAMPLE 7

The isocyanate solution was prepared. First, 8.95 g of poly-MDI was weighed into a polypropylene container with a screw cap. Subsequently 109.26 ml of acetone was added and the mixture was stirred to obtain a homogeneous solution. Next, 1.24 g of the silica aerogel powder prepared above was added slowly to this mixture blended until a homogeneous solution was obtained. 3.41 g of Jeffamine T-3000 polyamine was added to this mixture and blended until a homogeneous solution was obtained. To this solution 8.51 ml of TEA catalyst solution diluted in ethanol (10/90 wt/wt) was incorporated. After blending the solution for 1 min, the same method as described in Example 1 was used for the gelation and aging steps.

Once the aging process was completed and samples were cooled, the wet gel monolith samples were loaded into a pressure vessel and was subsequently supercritically dried using the same method as described in example 1. The resulting polyurea based aerogels reinforced with silica aerogel were opaque and had slightly yellow colors due to the color of the poly-MDI resins. Density of the obtained polyurea based aerogel monolith reinforced with silica aerogel fillers was 0.1557 g/cm³ (shrinkage factor of about 1.41). The pore structure of the obtained aerogel was characterized by using BET measurements. Results on the polyurea based aerogel monolith reinforced with silica aerogel fillers revealed a surface area of 320 m²/g, pore volume of 0.71 g/cm³, and an average nanopore diameter of 11.0 nm. The thermal conductivity coefficient of the polyurea based aerogel monolith reinforced with silica aerogel particles measured at a single temperature in air at atmospheric pressure was 16.7 mW/m K. A quartz fiber batting composite of this example showed a density of 0.1535 g/cm³ (shrinkage factor of about 1.39) and a thermal conductivity coefficient of 17.0 mW/m K.

### EXAMPLE 8

The isocyanate solution was prepared. First, 8.95 g of poly-MDI was weighed into a polypropylene container with a screw cap. Subsequently 109.26 ml of acetone was added and the mixture was stirred to obtain a homogeneous solution. Next, 2.47 g of the silica aerogel powder prepared above was added slowly to this mixture and blended until a homogeneous solution was obtained. 3.41 g of Jeffamine T-3000 polyamine was added to this mixture and blended until a homogeneous solution was obtained. To this solution 8.51 ml of TEA catalyst solution diluted in ethanol (10/90 wt/wt) was incorporated. After blending the solution for 1 min, the same method as described in Example 1 was used for the gelation and aging steps.

Once the aging process was completed, the wet gel was loaded into a pressure vessel and was subsequently supercritically dried using the same method as described in example 1. The resulting polyurea based aerogels reinforced with silica aerogel were opaque and had slightly yellow colors due to the color of the poly-MDI resins and showed a density of 0.1561 g/cm³ (shrinkage factor of about 1.29). The pore structure of the obtained aerogel was characterized by using BET measurements. Results on the polyurea based aerogel reinforced with silica aerogel fillers revealed a surface area of 325 m²/g, pore volume of 0.73 g/cm³, and an average nanopore diameter of 11.0 nm. The thermal conductivity coefficient of the polyurea aerogel monolith reinforced with silica aerogel fine particles measured at a single temperature in air at atmospheric pressure was 15.8 mW/m K. A quartz fiber batting composite of this example showed a density of 0.1525 g/cm³ (shrinkage factor of about 1.26) and a thermal conductivity coefficient of 16.0 mW/m K.

### EXAMPLE 9

The isocyanate solution was prepared. First, 8.95 g of poly-MDI was weighed into a polypropylene container with a screw cap. Subsequently 109.26 ml of acetone was added and the mixture was stirred to obtain a homogeneous solution. Next, 6.18 g of silica aerogel powder prepared above was added slowly to this mixture and blended until a homogeneous solution was obtained. 3.41 g of Jeffamine T-3000 polyamine was added to this mixture and blended until a homogeneous solution was obtained. To this solution 8.51 ml of TEA catalyst solution diluted in ethanol (10/90 wt/wt) was incorporated. After blending the solution for 1 min, the same method as described in example 1 was used for the gelation and aging steps.

Once the aging process was completed, the wet gel was loaded into a pressure vessel and was subsequently supercritically dried using the same method as described in example 1. The resulting polyurea based aerogels reinforced with silica aerogel fillers were opaque and less yellow than those of examples 1-3 due to the color of silica aerogel particle. Density of the obtained aerogel monolith was 0.1868 g/cm³ (shrinkage factor of about 1.22). The pore structure of the obtained gel was characterized by using BET measurements. Results on the polyurea based aerogel reinforced with silica aerogel fillers revealed a surface area of 360 m²/g, pore volume of 0.75 g/cm³, and an average nanopore diameter of 11.0 nm. The thermal conductivity coefficient of the polyurea based aerogel monolith reinforced with silica aerogel fine particles measured at a single temperature in air at atmospheric pressure was 16.3 mW/m K. A quartz fiber batting composite of this example showed a density of 0.1837 g/cm³ (shrinkage factor of 1.20) and a thermal conductivity coefficient of 16.0 mW/m K.

### EXAMPLE 10

The isocyanate solution was prepared. First, 8.95 g of poly-MDI was weighed into a polypropylene container with a screw cap. Subsequently 109.26 ml of acetone was added and the mixture was stirred to obtain a homogeneous solution. Next, 12.36 g of the silica aerogel powder prepared above was added slowly to this mixture and blended until a homogeneous solution was obtained. 3.41 g of Jeffamine T-3000 polyamine was added to this mixture and blended until a homogeneous solution was obtained. To this solution 8.51 ml of TEA catalyst solution diluted in ethanol (10/90 wt/wt) was incorporated. After blending the solution for 1 min, the same method as described in example 1 was used for the gelation and aging steps.

Once the aging process was completed, the wet gel was loaded into a pressure vessel and was subsequently supercritically dried using the same method as described in example 1. The resulting polyurea based aerogels reinforced with silica aerogel fillers were opaque and much less yellow than those of examples 1-4 due to the color of silica aerogel particle. Density of the obtained aerogel monolith was 0.2334 g/cm³ (shrinkage factor of about 1.12). The pore structure of the obtained gel was characterized by using BET measurements. Results on the polyurea based aerogel reinforced with silica aerogel fillers revealed a surface area of 490 m²/g, pore volume of 0.95 g/cm³, and an average nanopore diameter of 10.1 nm. The thermal conductivity coefficient of the polyurea aerogel monolith reinforced with silica aerogel mocroparticles measured at a single temperature in air at atmospheric pressure was 13.5 mW/m K. A quartz fiber batting composite of this example showed a density of 0.2313 g/cm³ (shrinkage factor of 1.11) and a thermal conductivity coefficient of the polyurea aerogel composite reinforced with silica aerogel fine particles was 13.8 mW/mK.

TABLE 1

| | | | Thermal Conductivity |
|---|---|---|---|
| | | | mW/mK (atmospheric |
| | | Density | pressure and |
| Example | Material | g/cm³ | room temperature) |
| 1 | Polyurea aerogel | 0.0912 | 19.5 |
| 2 | Polyurea aerogel with Silica | 0.0907 | 18.9 |
| | aerogel filler (10%) | | |
| 3 | Polyurea aerogel with Silica | 0.0948 | 16.2 |
| | aerogel filler (20%) | | |
| 4 | Polyurea aerogel with Silica | 0.1131 | 15.2 |
| | aerogel filler (50%) | | |
| 5 | Polyurea aerogel with Silica | 0.1451 | 14.0 |
| | aerogel filler (100%) | | |
| 6 | Polyurea aerogel | 0.152 | 20.9 |
| 7 | Polyurea aerogel with Silica | 0.1557 | 16.7 |
| | aerogel filler (10%) | | |
| 8 | Polyurea aerogel with Silica | 0.1561 | 15.8 |
| | aerogel filler (20%) | | |
| 9 | Polyurea aerogel with Silica | 0.1868 | 16.3 |
| | aerogel filler (50%) | | |
| 10 | Polyurea aerogel with Silica | 0.2334 | 13.8 |
| | aerogel filler (100%) | | |

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention. All of the embodiments of the present invention may be practiced with the embodiments known in the prior art or references incorporated in this document.

What is claimed is:

1. A composite comprising an organic aerogel matrix and inorganic aerogel fillers incorporated in the matrix.

2. The composite of claim 1 wherein the inorganic aerogel fillers comprise silica, titania, zirconia, alumina, hafnia, yttria, ceria, nitrides, carbides or a combination thereof.

3. The composite of claim 2 wherein the organic aerogel to inorganic aerogel filler weight ratio is between about 1:0.01 and about 1:2, respectively.

4. The composite of claim 3 wherein the fillers have sizes between about 0.01 μm and about 100 μm or between about 0.5 μm and about 50 μm.

5. The composite of claim 4 wherein the average pore size of the fillers is between 0.1 nm and about 200 nm.

6. The composite of claim 5 wherein the fillers have a pore volume greater than about 2.0 cm³/g.

7. The organic aerogel of claim 6 wherein the fillers have a surface area greater than about 500 m²/g.

8. The composite of claim 1 having a density between about 0.01 g/cm³ and about 0.4 g/cm³.

9. The composite of claim 1 wherein the organic aerogel matrix comprises isocyanates, polyisocyantes, polyurea, polyurethane, polybutadiene, polycyanurates, polyacrylates, polystyrenes, cellulose, poly-dicyclopentadiene, polyacrylonitriles, poly-imides, polyfurfuryl alcohol, phenol furfuryl alcohol, melamine formaldehydes, resorcinol formaldehydes, cresol formaldehyde, phenol formaldehyde, phloroglucinol formaldehyde, polyvinyl alcohol dialdehyde, polyacrylamides, epoxies, agar, agarose, or a combination thereof.

10. The composite of claim 1 further comprising a fibrous structure.

11. The composite of claim 10 wherein the fibrous structure is in a woven, non-woven, mat, felt, batting, chopped fibers or a combined form.

12. The composite of claim 1 further comprising opacifiers.

13. The composite of claim 1 wherein the opacifiers comprise B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or a mixture thereof.

14. A method of preparing a composite material comprising the steps of: forming a composite gel from a mixture comprising organic gel precursors, inorganic aerogel fillers; and drying said composite gel using supercritical fluids.

15. The method of claim 14 wherein the organic gel precursors comprise isocyanates, polyisocyantes, polyurea, polyurethane, polybutadiene, polycyanurates, polyacrylates, polystyrenes, cellulose, polydicyclopentadiene, polyacrylonitriles, polyimides, polyfurfuryl alcohol, phenol furfuryl alcohol, melamine formaldehydes, resorcinol formaldehydes, cresol formaldehyde, phenol formaldehyde, phloroglucinol formaldehyde, polyvinyl alcohol dialdehyde, polyacrylamides, epoxies, agar, agarose, or a combination thereof.

16. The method of claim 14 wherein the inorganic aerogel fillers comprise silica, titania, zirconia, alumina, hafnia, yttria, ceria, nitrides, carbides or a combination thereof.

17. The method of claim 14 wherein the mixture comprises at least one catalyst

18. The method of claim 14 wherein the mixture comprises opacifiers.

19. The method of claim 18 wherein the opacifiers comprise B₄C, Diatomite, Manganese ferrite, MnO, NiO, SnO, Ag₂O, Bi₂O₃, TiC, WC, carbon black, titanium oxide, iron titanium oxide, zirconium silicate, zirconium oxide, iron (I) oxide, iron (III) oxide, manganese dioxide, iron titanium oxide (ilmenite), chromium oxide, silicon carbide or a mixture thereof.

20. The method of claim 14 further comprising the step of combining a fibrous material with the mixture.
